(19) United States
(12) Patent Application Publication
(10) Pub. No.: US 2026/0241750 A1
(43) Pub. Date: Aug. 20, 2026

(54) Tire

(71) Applicant: The Yokohama Rubber Co., LTD., Kanagawa (JP)

(72) Inventor: Hiroki DEWA, Kanagawa (JP)

(21) Appl. No.: 19/538,429

(22) Filed: Feb. 12, 2026

(30) Foreign Application Priority Data
Feb. 17, 2025 (JP) 2025-023432

(51) Int. Cl. B60C 9/20

(52) U.S. Cl. CPC B60C 9/2006

(57) ABSTRACT

A belt layer includes: an outer cross belt including a belt cord angle θ1 of 45° or more relative to the circumferential direction as an absolute value; an inner cross belt including a belt cord angle θ2 of 45° or less relative to the circumferential direction as an absolute value with a sign opposite to that of the outer cross belt cord angle and disposed radially inward of the outer cross belt; and a reinforcing layer including a belt cord angle within a range of ±5° relative to the circumferential direction and disposed between the inner and outer cross belts. A width W1 of the reinforcing layer in the width direction, a width W2 of the inner cross belt in the width direction, and a width W3 of the outer cross belt in the width direction satisfy W1<W3<W2.

### CROSS-REFERENCE TO RELATED APPLICATION

This application claims priority pursuant to 35 U.S.C. 119(a) to Japanese Patent Application No. 2025-023432, filed February 17, 2025, which application is incorporated herein by reference in its entirety.

### FIELD OF THE INVENTION

The technology relates to a tire.

### BACKGROUND OF THE INVENTION

For example, Japan Patent No. 5525073 B describes a heavy duty tire that reduces wear of a shoulder edge while maintaining durability of a plunger. The heavy duty tire includes a first belt layer composed of cords extending and inclined at an angle greater than 45° with respect to a tire circumferential direction, a second belt layer composed of cords extending in the tire circumferential direction, and a third belt layer composed of cords extending in a direction opposite to the cords of the first belt layer and inclined at an angle of 30° or less with respect to the tire circumferential direction, the first, second, and third belt layers being sequentially disposed from an inner side in a tire radial direction. A width w3 of the third belt layer is set to 80% or more of a tread width w, a width of the first belt layer is w1, a width of the second belt layer is w2, and w2 < w1 < w3 is satisfied.

To increase added values such as increasing actual load capacity of a vehicle and improving fuel efficiency, weight reduction of a tire is awaited. Although the weight reduction of a tire can be achieved by a belt structure of the tire, depending on the belt structure, belt edge separation may occur due to distortion near a belt edge.

### SUMMARY OF THE INVENTION

The technology provides a tire that can provide belt edge separation resistance and weight reduction of the tire in a compatible manner.

A tire according to an aspect of the present technology includes: a carcass layer; a belt layer disposed on an outer side of the carcass layer in a tire radial direction and continuing in a tire circumferential direction; and a tread rubber disposed on an outer side of the belt layer in the tire radial direction, the belt layer includes: a radially outer cross belt including a belt cord having a cord angle of 45° or more with respect to the tire circumferential direction as an absolute value; a radially inner cross belt including a belt cord having a cord angle of 45° or less with respect to the tire circumferential direction as an absolute value with a sign opposite to that of the cord angle of the radially outer cross belt and disposed on an inner side of the radially outer cross belt in the tire radial direction; and a circumferential reinforcing layer including a belt cord having a cord angle within a range of ±5° with respect to the tire circumferential direction and disposed between the radially inner cross belt and the radially outer cross belt, and a width W1 of the circumferential reinforcing layer, a width W2 of the radially inner cross belt, and a width W3 of the radially outer cross belt satisfy a relationship W1 < W3 < W2.

The technology allows belt edge separation resistance and weight reduction of the tire to be provided in a compatible manner.

### BRIEF DESCRIPTION OF DRAWINGS

FIG. 1 is a meridian cross-sectional view of a pneumatic tire according to an embodiment;

FIG. 2 is a development view of a belt layer of the pneumatic tire according to an embodiment;

FIG. 3 is a table showing results of performance tests of pneumatic tires according to embodiments;

FIG. 4 is a table showing results of performance tests of pneumatic tires according to embodiments;

FIG. 5 is a table showing results of performance tests of pneumatic tires according to embodiments;

FIG. 6 is a table showing results of performance tests of pneumatic tires according to embodiments; and,

FIG. 7 is a table showing results of performance tests of pneumatic tires according to embodiments.

### DETAILED DESCRIPTION OF THE INVENTION

An embodiment according to the present technology will be described in detail below with reference to the drawings. Note that the technology is not limited to the embodiment. Constituents of the embodiment include elements that are substitutable and obviously substitutable while maintaining consistency with the technology. A plurality of modified examples described in the embodiment can be combined as appropriate within the scope of obviousness to one skilled in the art.

In the following description, the term "tire radial direction" refers to a direction orthogonal to a tire rotation axis (not illustrated), which is a rotation axis of a pneumatic tire 1 according to an embodiment, the term "inner side in a tire radial direction" refers to a side toward the tire rotation axis in the tire radial direction, and the term "outer side in the tire radial direction" refers to a side away from the tire rotation axis in the tire radial direction. The term "tire circumferential direction" refers to a circumferential direction about the tire rotation axis as a center axis. The term "tire width direction" refers to a direction parallel with the tire rotation axis, the term "inner side in the tire width direction" refers to a side toward a tire equatorial plane (tire equator line) CL in the tire width direction, and the term "outer side in the tire width direction" refers to a side away from the tire equatorial plane CL in the tire width direction. The term "tire equatorial plane CL" refers to a plane that is orthogonal to the tire rotation axis and that passes through the center of a tire width of the pneumatic tire 1. The tire equatorial plane CL aligns, in a position in the tire width direction, with a center line in the tire width direction corresponding to a center position of the pneumatic tire 1 in the tire width direction. The term "tire equator line" refers to a line on the tire equatorial plane CL and along the tire circumferential direction of the pneumatic tire 1. The term "cross-section in the tire meridian direction (meridian cross-sectional view)" refers to a cross-section of the tire taken along a plane that includes the tire rotation axis.

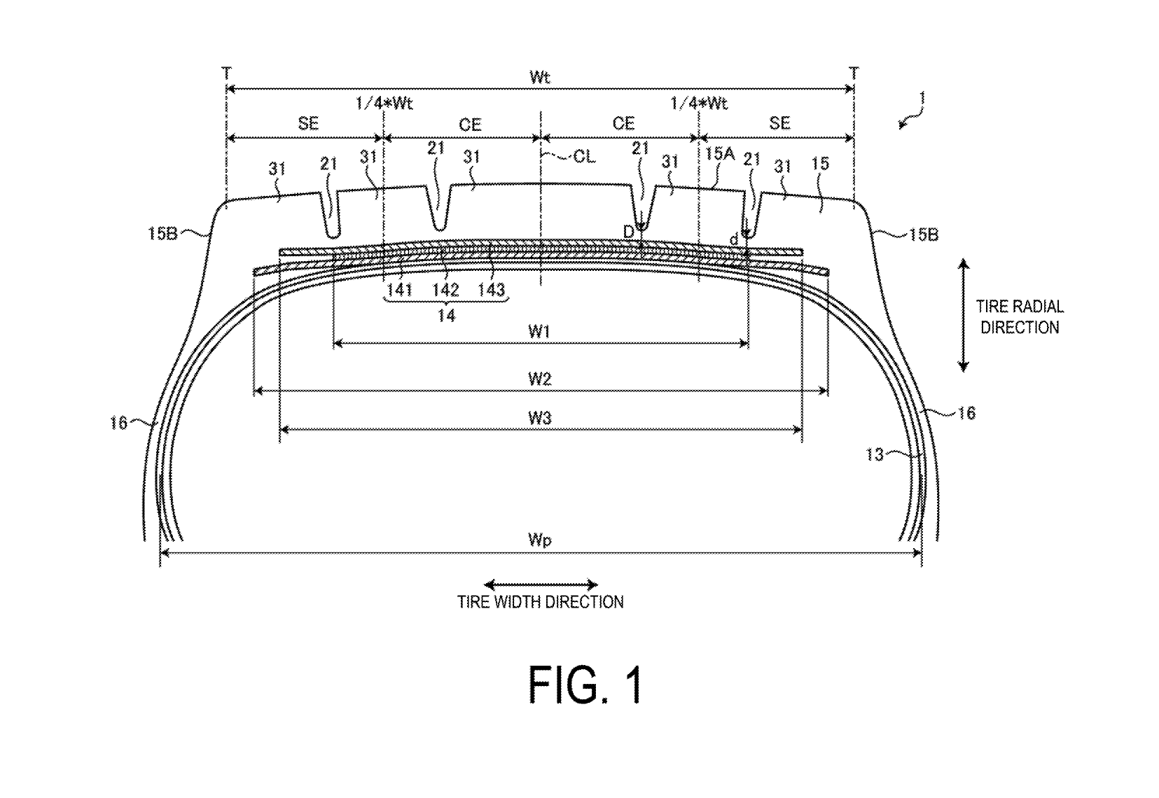

FIG. 1 is a meridian cross-section of the pneumatic tire 1 according to an embodiment and illustrates a cross-section of a region on one side of the tire rotation axis in the tire radial direction. In the present embodiment, a heavy duty pneumatic radial tire mounted on a heavy load vehicle such as a truck or bus will be described as an example. The pneumatic tire 1 according to the present embodiment is particularly suitable for use as an all-season tire.

The pneumatic tire 1 according to the embodiment has an annular structure with the tire rotation axis as its center, and although not illustrated in the diagram, includes a pair of bead cores, a pair of bead fillers, and a pair of rim cushion rubbers, and as illustrated in FIG. 1, a carcass layer 13, a belt layer 14, a tread rubber 15, and a pair of sidewall rubbers 16.

The pair of bead cores are formed by winding one or more bead wires made of steel annularly multiple times, are embedded in bead portions, and constitute cores of the bead portions on both sides in the tire width direction. The pair of bead fillers are each disposed on an outer side in the tire radial direction and reinforce the bead portions of the pair of bead cores. The pair of rim cushion rubbers extend from an inner side in the tire radial direction of the respective bead cores and turned back portions of the carcass layer 13 toward the outer side in the tire width direction and constitute rim fitting surfaces of the bead portions.

The carcass layer 13 has a single-layer structure including one carcass ply or a multilayer structure including a plurality of carcass plies layered. The carcass layer 13 extends between the bead cores in a toroidal shape, thereby forming the framework of the tire. Both end portions of the carcass layer 13 are turned back toward the outer side in the tire width direction and fixed to wrap the bead cores and the bead fillers. The carcass ply of the carcass layer 13 is formed by covering, with coating rubber, a plurality of carcass cords made of steel and by performing a rolling process on the carcass cords and has a cord angle (defined as an inclination angle in a longitudinal direction of the carcass cords with respect to the tire circumferential direction and also referred to as a belt angle) of 80° or more and 100° or less as an absolute value for a radial tire and 30° or more and 45° or less for a bias tire.

The belt layer 14 is formed by layering at least three belt plies 141 to 143, wound around the outer circumference of the carcass layer 13, and is disposed continuously in the tire circumferential direction. These belt plies 141 to 143 include a radially inner cross belt 141, a radially outer cross belt 143, and a circumferential reinforcing layer 142.

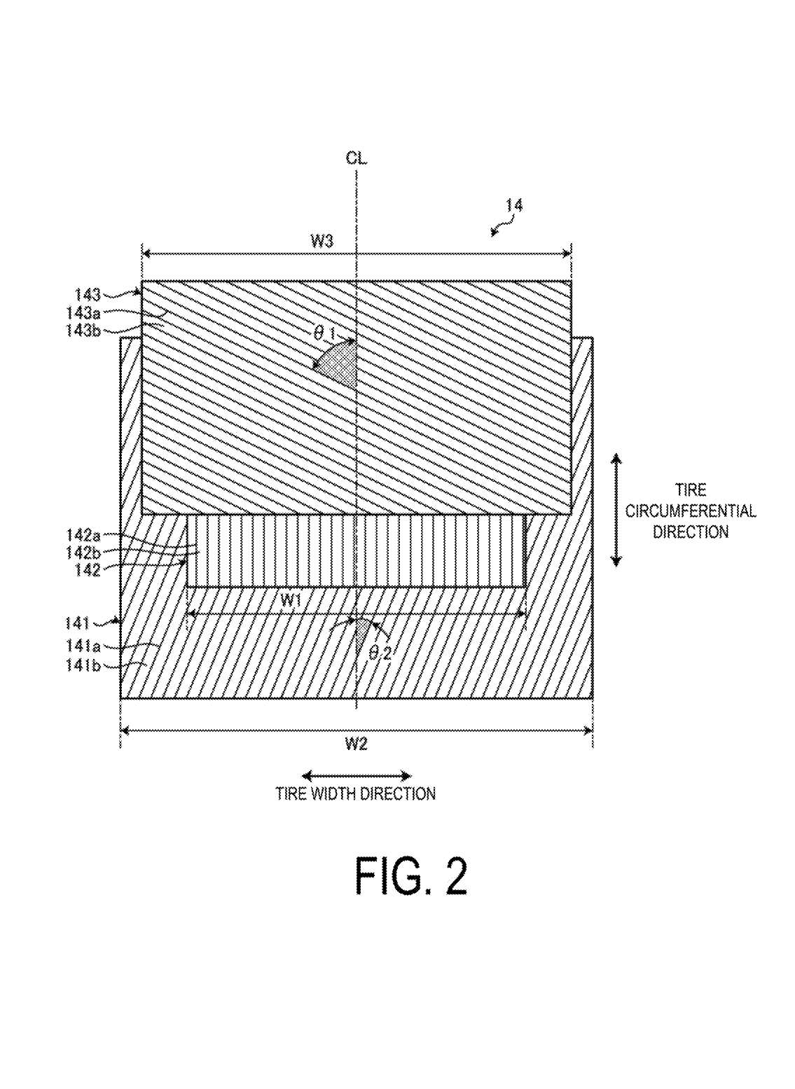

The radially inner cross belt 141 of the three belt plies is disposed on the inner side in the tire radial direction. As illustrated in FIG. 2, the radially inner cross belt 141 is formed by covering, with coating rubber 141b, a plurality of belt cords 141a made of steel and by performing a rolling process on the belt cords. In the radially inner cross belt 141, the belt cord 141a has a cord angle θ2 of 45° or less with respect to the tire circumferential direction as an absolute value. In the radially inner cross belt 141, the cord angle θ2 of the belt cord 141a is preferably 0° or more and 44° or less as an absolute value.

The radially outer cross belt 143 of the three belt plies is disposed on the outer side in the tire radial direction. As illustrated in FIG. 2, the radially outer cross belt 143 is formed by covering, with coating rubber 143b, a plurality of belt cords 143a made of steel and by performing a rolling process on the belt cords. In the radially outer cross belt 143, the belt cord 143a has a cord angle θ1 of 45° or more with respect to the tire circumferential direction as an absolute value with a sign opposite to that of the cord angle θ2 of the radially inner cross belt 141. The radially outer cross belt 143 is also simply referred to as a cross belt together with the radially inner cross belt 141. In the radially outer cross belt 143, the cord angle θ1 of the belt cord 143a is preferably 46° or more and 90° or less as an absolute value.

The circumferential reinforcing layer 142 of the three belt plies is disposed between the radially inner cross belt 141 and the radially outer cross belt 143. As illustrated in FIG. 2, the circumferential reinforcing layer 142 is formed by covering, with coating rubber 142b, a plurality of belt cords 142a made of steel and by performing a rolling process on the belt cords. In the circumferential reinforcing layer 142, the belt cord 142a has a cord angle within a range of ±5° with respect to the tire circumferential direction as an absolute value.

As illustrated in FIG. 1, the tread rubber 15 is disposed on an outer side of the carcass layer 13 and the belt layer 14 in the tire radial direction and constitutes a tread portion of the pneumatic tire 1. The tread rubber 15 includes a tread surface (tread contact surface) 15A on an outer circumferential surface that comes into contact with a road surface during travel. An end portion of the tread surface 15A on the outer side in the tire width direction is a ground contact edge T. The tread rubber 15 includes, on a side portion on both outer sides in the tire width direction from the ground contact edge T on the tread surface 15A, a buttress portion 15B that does not come into contact with a road surface during travel. The buttress portion 15B is provided in the tread rubber 15 from the ground contact edge T to the outer side in the tire width direction and the inner side of the tire radial direction, i.e., to the sidewall rubber 16. The buttress portion 15B is formed in a trapezoidal shape having a dimension in the tire width direction, which increases from the outer side in the tire radial direction to the inner side in the tire radial direction.

The ground contact edge T is defined as a maximum width position in the tire width direction of the contact surface between the tire and a flat plate when the tire is mounted on a specified rim, inflated to a specified internal pressure in an unloaded state (inflated state), placed perpendicular to the flat plate in a static state, and loaded with a load corresponding to a specified load.

"Specified rim" refers to a "standard rim" defined by the Japan Automobile Tyre Manufacturers Association, Inc. (JATMA), a "Design Rim" defined by the Tire and Rim Association, Inc. (TRA), or a "Measuring Rim" defined by the European Tyre and Rim Technical Organisation (ETRTO). "Specified internal pressure" refers to a "maximum air pressure" specified by JATMA, the maximum value in "TIRE LOAD LIMITS AT VARIOUS COLD INFLATION PRESSURES" specified by TRA, or "INFLATION PRESSURES" specified by ETRTO. "Specified load" refers to a "maximum load capacity" specified by JATMA, the maximum value in "TIRE LOAD LIMITS AT VARIOUS COLD INFLATION PRESSURES" specified by TRA, or "LOAD CAPACITY" specified by ETRTO. In the case of the pneumatic tire 1 according to the embodiment, the specified load is 88% of the maximum load capacity at the specified internal pressure.

The pair of sidewall rubbers 16, 16 are each disposed on an outer side of the carcass layer 13 in the tire width direction and constitute sidewall portions on both sides in the tire width direction.

As illustrated in FIG. 1, the pneumatic tire 1 according to the embodiment includes, on the tread surface 15A, circumferential grooves 21 extending in the tire circumferential direction and a plurality of land portions 31 defined by the circumferential groove 21.

The circumferential grooves 21 are provided to extend in the tire circumferential direction, and each circumferential groove 21 has an annular structure extending continuously and linearly along the entire circumference of the tire. The circumferential groove 21 may be defined as a groove having a wear indicator as specified by JATMA mandatorily provided. The circumferential groove 21 has a groove width of 5 mm or more and 20 mm or less and a groove depth of 7 mm or more and 30 mm or less.

Here, the groove width is measured as a maximum value of a distance between opposed groove walls or edges of an opening end portion on the tread surface 15A when the tire is mounted on a specified rim, inflated to the specified internal pressure, and in an unloaded state. The groove depth is measured as the maximum value of a distance from the tread surface 15A to the groove bottom when the tire is mounted on a specified rim, inflated to the specified internal pressure, and in an unloaded state. In a configuration in which partial recessed and protruding portions or a sipe is included at a groove bottom, the groove depth is measured excluding the partial recessed and protruding portions or the sipe.

As illustrated in FIG. 1, in the pneumatic tire 1 according to the embodiment, the circumferential groove 21 includes a groove disposed in a center region CE of the tread surface 15A and a groove disposed in a shoulder region SE of the tread surface 15A. In the embodiment, one circumferential groove 21 is disposed in each center region CE with the tire equatorial plane CL as a boundary, and one circumferential groove 21 is disposed in each shoulder region SE with the tire equatorial plane CL as a boundary.

The center region CE is a region within a range of one quarter (1/4 Wt) from the tire equatorial plane CL to the both outer sides in the tire width direction, with respect to a ground contact width Wt (the dimension measured when the tire is mounted on a specified rim, inflated to the specified internal pressure, and in an unloaded state) of the tread surface 15A (the tread rubber 15) between the both ground contact edges T. The shoulder region SE is a region within a range of one quarter (1/4 Wt) from each of the ground contact edges T to the inner side in the tire width direction, with respect to the ground contact width Wt of the tread surface 15A between both ground contact edges T.

The land portions 31 each extend over the entire circumference of the tire and form an annular road contact surface (a ground contact surface). The land portions 31 include a center land portion disposed in the center region CE, middle land portions each extending over the center region CE and the shoulder region SE, and shoulder land portions each disposed on an outermost side in the tire width direction in the shoulder region SE.

As illustrated in FIGS. 1 and 2, the pneumatic tire 1 according to the embodiment includes: as its characteristics, the carcass layer 13; the belt layer 14 disposed on an outer side of the carcass layer 13 in the tire radial direction and continuing in the tire circumferential direction; and the tread rubber 15 disposed on an outer side of the belt layer 14 in the tire radial direction, the belt layer 14 includes: the radially outer cross belt 143 including the belt cord 143a having the cord angle θ1 of 45° or more with respect to the tire circumferential direction as an absolute value; the radially inner cross belt 141 including the belt cord 141a having the cord angle θ2 of 45° or less with respect to the tire circumferential direction as an absolute value with a sign opposite to that of the cord angle θ1 of the radially outer cross belt 143 and disposed on an inner side of the radially outer cross belt 143 in the tire radial direction; and the circumferential reinforcing layer 142 including the belt cord 142a having the cord angle within a range of ±5° with respect to the tire circumferential direction and disposed between the radially inner cross belt 141 and the radially outer cross belt 143, and a width W1 of the circumferential reinforcing layer 142 in the tire width direction, a width W2 of the radially inner cross belt 141 in the tire width direction, and a width W3 of the radially outer cross belt 143 in the tire width direction satisfy a relationship W1 < W3 < W2. Here, each of the belt widths W1, W2, and W3 is a value measured when the tire is mounted on a specified rim, inflated to the specified internal pressure, and in an unloaded state.

In the pneumatic tire 1, the radially outer cross belt 143 functions as a belt ply including the belt cord 143a with relatively large angle, ensuring rigidity in the tire width direction. In the pneumatic tire 1, the circumferential reinforcing layer 142 and the radially inner cross belt 141 function as belt plies including the belt cords 142a and 141a with relatively small angle, ensuring rigidity in the tire circumferential direction. The pneumatic tire 1 alleviates, by setting the arrangement of the belt plies 141 to 143 and the cord angles of the belt cords to be within the specified ranges, variations in rigidity of the tread portion in the tire width direction and causes strain near the belt edge to be shared by the edges of the belt plies 141 to 143, improving tire durability in terms of belt edge separation. In addition, the pneumatic tire 1 can have, by making the relationship between the widths W1, W2, and W3 of the belt plies 141 to 143 satisfy W1 < W3 < W2, a sufficient rubber layer from the end portion in the tire width direction of each of the belt plies 141 to 143 to the external contour profile of the buttress portion 15B, improving tire durability in terms of belt edge separation.

Moreover, the pneumatic tire 1 improves tire durability as described above, allowing the belt layer 14 to have a three-layer structure of the radially inner cross belt 141, the circumferential reinforcing layer 142, and the radially outer cross belt 143 and achieving weight reduction of the tire. For example, although not illustrated in the drawing, the pneumatic tire 1 allows a small-angle belt to be disposed on an outer side of the radially outer cross belt 143 in the tire radial direction and allows a large-angle belt to be disposed on an inner side of the radially inner cross belt 141 in the tire radial direction; however, the small-angle belt and the large-angle belt can be eliminated.

Here, in the small-angle belt, the range of width in the tire width direction includes the positions of the circumferential grooves 21 in the center region CE and that the width is less than 90% of the width W3 of the radially outer cross belt 143. The small-angle belt is formed by covering a plurality of belt cords made of steel with coating rubber and performing a rolling process on the belt cords. In the small-angle belt, the belt cord has a cord angle of 10° or more and 45° or less (preferably 20°) with respect to the tire circumferential direction as an absolute value with the same sign as that of the cord angle of the radially outer cross belt 143. The small-angle belt protects the radially outer cross belt 143 from, for example, an event in which a stone enters the groove bottom of the circumferential groove 21.

In the large-angle belt, the range of width in the tire width direction includes the positions of the circumferential grooves 21 in the center region CE and the shoulder region SE and that the width is less than 100% of the width W3 of the radially outer cross belt 143 and less than 95% of the width W2 of the radially inner cross belt 141. The large-angle belt includes, for example, a belt cord having a cord angle of 45° or more and 70° or less (preferably 60°) with respect to the tire circumferential direction as an absolute value with the same sign as that of the cord angle of the radially inner cross belt 141. The large-angle belt ensures, for example, rigidity in the tire width direction.

In the pneumatic tire 1 according to the embodiment, the width W1 of the circumferential reinforcing layer 142 and a cross-sectional width Wp of the carcass layer 13 satisfy a relationship 0.50 ≤ W1/Wp ≤ 0.70.

The cross-sectional width Wp of the carcass layer 13 is the largest cross-sectional dimension in the tire width direction of the carcass cords excluding the coating rubber of the carcass layer 13 and is the dimension between both outermost sides in the tire width direction of the carcass cords.

The pneumatic tire 1 allows, by setting the width W1 of the circumferential reinforcing layer 142 in the range described above, the internal pressure distribution between the belt layer 14 and the carcass layer 13 when the tire is inflated to be set in a well-balanced manner, improving overall tire durability. To obtain the above effect, the pneumatic tire 1 preferably satisfies a relationship 0.55 ≤ W1/Wp ≤ 0.67.

In the pneumatic tire 1 according to the embodiment, the width W1 of the circumferential reinforcing layer 142 and the width W2 of the radially inner cross belt 141 satisfy 1.25 ≤ W2/W1 ≤ 1.55, and the width W2 of the radially inner cross belt 141 and the width W3 of the radially outer cross belt 143 satisfy a relationship W2 - W3 ≤ 30 mm.

In the pneumatic tire 1, setting the width W1 of the circumferential reinforcing layer 142 in the range described above is effective in increasing rigidity in the tire circumferential direction. In addition, the pneumatic tire 1 can have, by setting the difference between the width W2 of the radially inner cross belt 141 and the width W3 of the radially outer cross belt 143 in the range described above, a sufficient rubber layer in the tire radial direction at an end portion of the cross belt composed of the radially inner cross belt 141 and the radially outer cross belt 143 and reduce the difference between the widths of the cross belts. This can increase a range of the hoop effect of the cross belts and further improve tire durability. To obtain the above effect, the pneumatic tire 1 preferably satisfies relationships 1.30 ≤ W2/W1 ≤ 1.45 and W2 - W3 ≤ 20 mm.

In the pneumatic tire 1 according to the embodiment, the radially outer cross belt 143 is disposed adjacent to the tread rubber 15. In other words, in the pneumatic tire 1 according to the embodiment, no belt including a belt cord (for example, the small-angle belt described above) is between the radially outer cross belt 143 and the tread rubber 15 on the outer side of the radially outer cross belt 143 in the tire radial direction.

The pneumatic tire 1 can ensure, by including the circumferential reinforcing layer 142, rigidity in the tire circumferential direction, eliminating the small-angle belt and achieving weight reduction.

In the pneumatic tire 1 according to the embodiment, the radially inner cross belt 141 is disposed adjacent to the carcass layer 13. In other words, no belt including a belt cord (for example, the large-angle belt described above) is between the radially inner cross belt 141 and the carcass layer 13 on an inner side of the radially inner cross belt 141 in the tire radial direction.

In a belt structure of a general heavy duty tire, a large-angle belt that secures rigidity in the tire width direction is disposed on an inner side of a cross belt in the tire radial direction. In the pneumatic tire 1, however, the radially outer cross belt 143 functioning as a large-angle belt ensures rigidity in the tire width direction, eliminating the large-angle belt and achieving weight reduction.

In the pneumatic tire 1 according to the embodiment, the belt cords 142a of the circumferential reinforcing layer 142 are steel wire, and the number of ends of the circumferential reinforcing layer 142 is 15 ends/50 mm or more and 30 ends/50 mm or less.

The number of ends is the number of belt cords per 50 mm in the tire circumferential direction when the pneumatic tire is mounted on a regular rim, inflated to a regular internal pressure, and in an unloaded state, and the unit is cords/50 mm.

The pneumatic tire 1 allows, by setting the number of ends of the circumferential reinforcing layer 142 within a specified range, the rigidity of the tread portion to be properly set, and reducing strain of the groove bottom of the circumferential groove 21 and the belt edge of the belt layer 14 improves tire durability in terms of belt edge separation.

The pneumatic tire 1 according to the embodiment further includes at least two circumferential grooves 21 extending in the circumferential direction in the tread rubber 15. The circumferential grooves 21 are in the center region CE and the shoulder region SE of the tread surface 15A. As illustrated in FIG. 1, a thickness D from the circumferential groove 21 in the center region CE to the belt layer 14 and a thickness d from the circumferential groove 21 in the shoulder region SE to the belt layer 14 satisfy a relationship 0.8 < D/d < 1.3. Here, D and d are values measured when the tire is mounted on a specified rim, inflated to the specified internal pressure, and in an unloaded state.

The pneumatic tire 1 improves, by setting distances from the groove bottom of the circumferential groove 21 to the belt cord of the belt layer 14 to be equal at positions of the circumferential grooves 21 in the center region CE and the shoulder region SE and dispersing strain of the tread surface 15A in the tire width direction in a well-balanced manner, tire durability in terms of belt edge separation. To obtain the above effect, the pneumatic tire 1 preferably satisfies a relationship 0.9 ≤ D/d ≤ 1.1.

In the pneumatic tire 1 according to the embodiment, the ground contact width Wt of the tread surface 15A (tread rubber 15) and the cross-sectional width Wp of the carcass layer 13 satisfy a relationship 0.60 ≤ Wt/Wp ≤ 0.95. Here, Wp is a value measured when the tire is mounted on a specified rim, inflated to the specified internal pressure, and in an unloaded state.

The pneumatic tire 1 can maintain, by setting the relationship between the ground contact width Wt of the tread surface 15A and the cross-sectional width Wp of the carcass layer 13 to be within a specified range, an appropriate balance of a carcass internal pressure distribution ratio at a portion on the outer side in the tire width direction of the tread rubber 15 (also, referred to as the shoulder portion) when the tire is inflated, allowing improvement in the overall durability performance of the tire to be expected in terms of reducing strain in deflection at the time of ground contact. To obtain the above effect, the pneumatic tire 1 preferably satisfies a relationship 0.70 ≤ Wt/Wp ≤ 0.85.

In the pneumatic tire 1 according to the embodiment, the belt layer 14 is composed of three belt plies of the radially inner cross belt 141, the radially outer cross belt 143, and the circumferential reinforcing layer 142.

The pneumatic tire 1 achieves weight reduction by reducing the number of belts.

In the present embodiment, as described above, the pneumatic tire 1 is described as an example of a tire. The pneumatic tire 1 can be inflated with air, inert gas such as nitrogen, and other gases. However, the configuration of the tread pattern of the pneumatic tire 1 described in the present embodiment can also be applied to other tires within the scope apparent to one skilled in the art. Examples of other tires include an airless tire and a solid tire.

### Examples

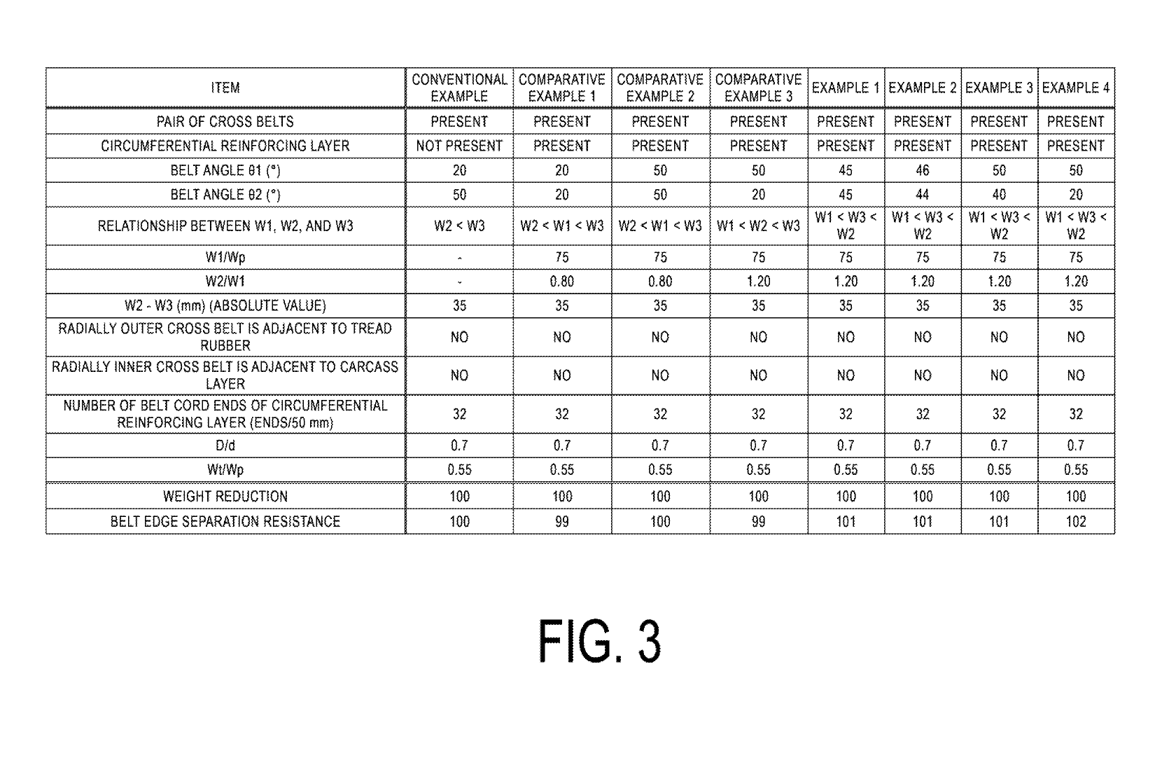

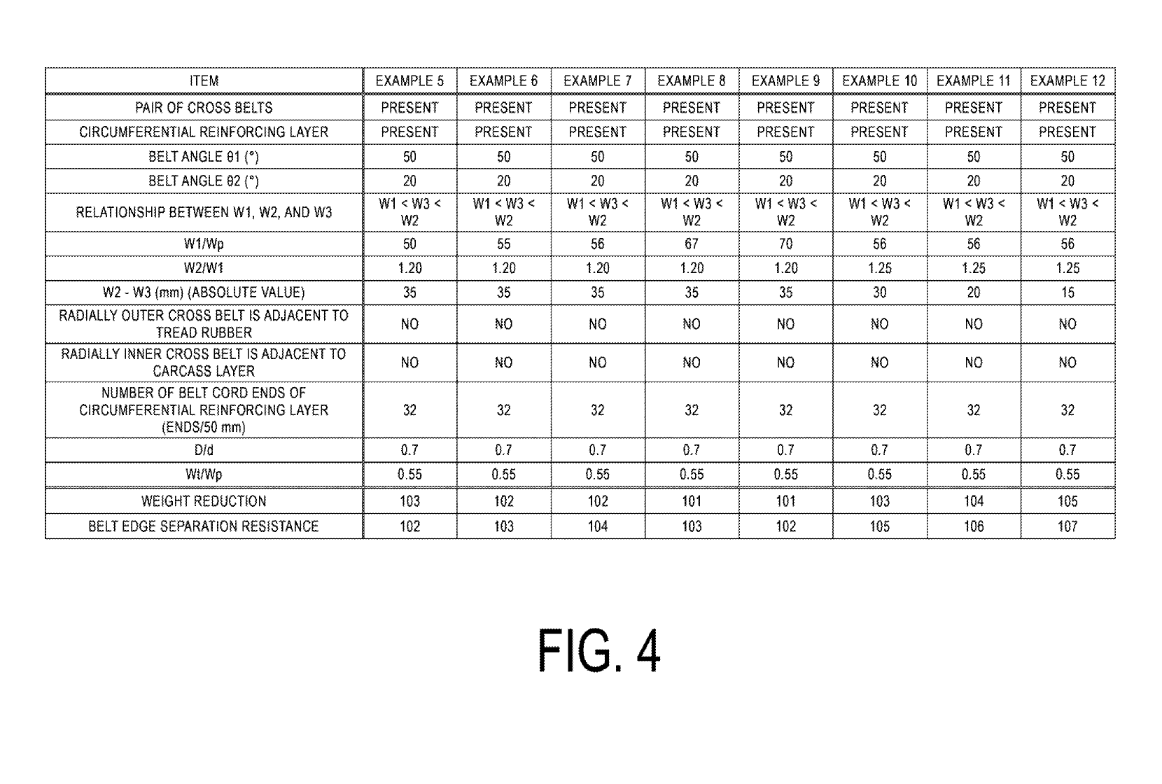

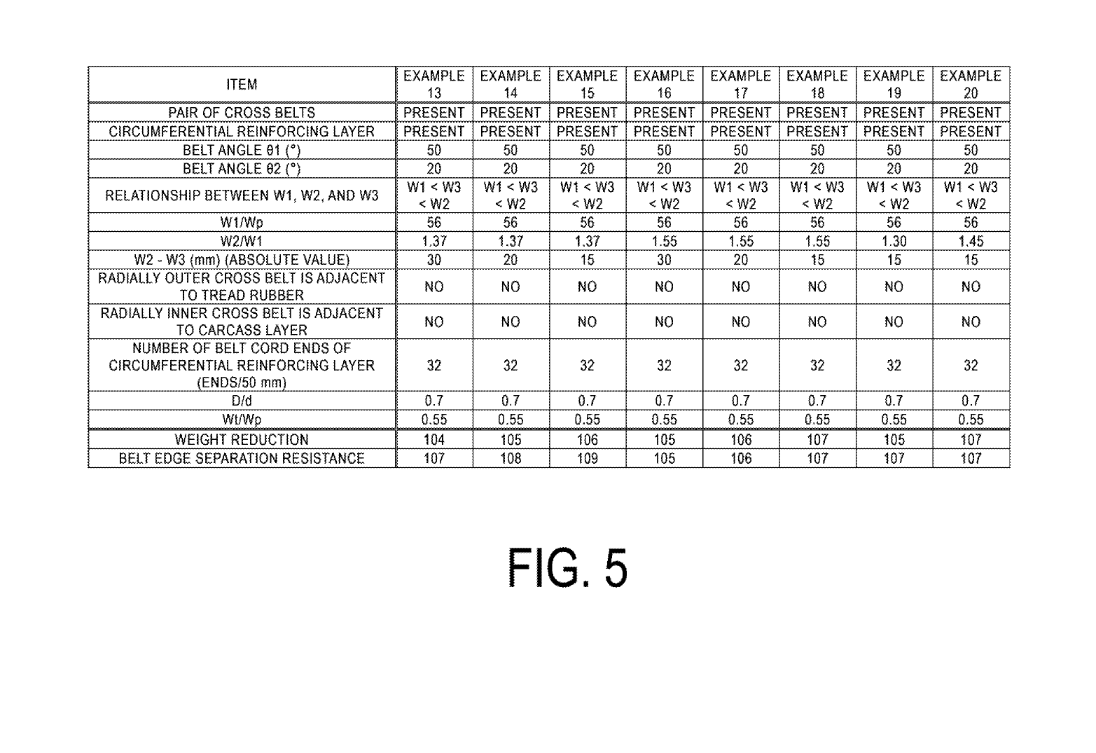

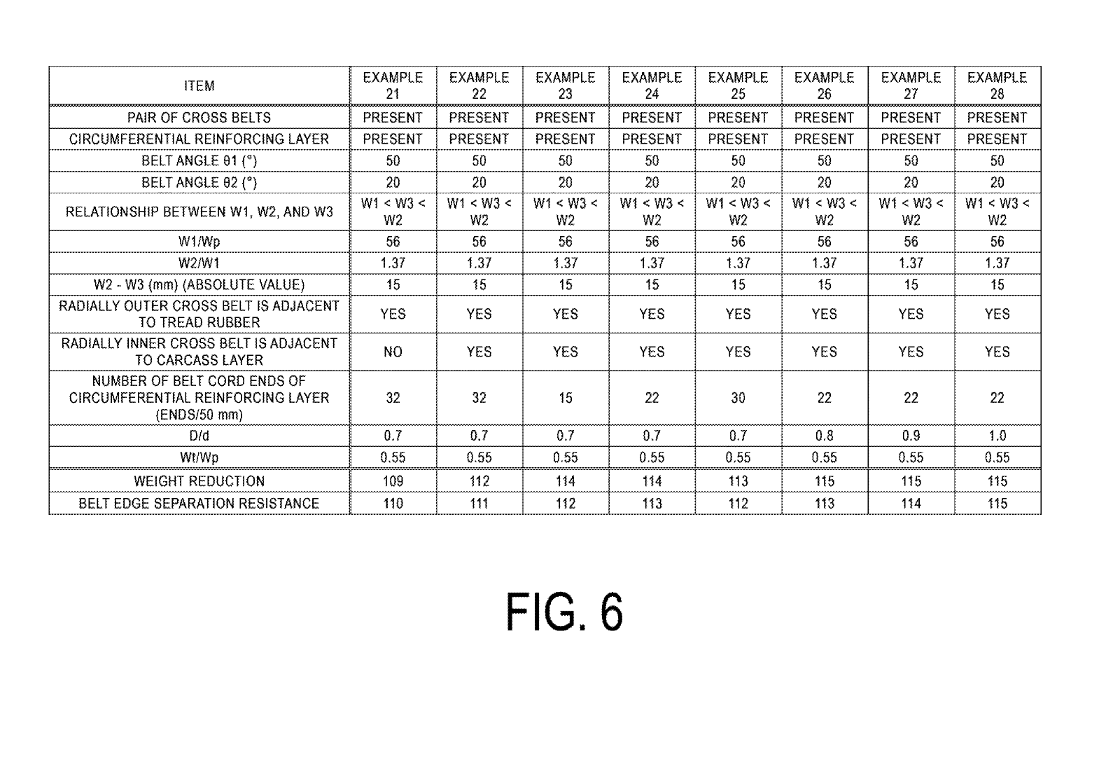

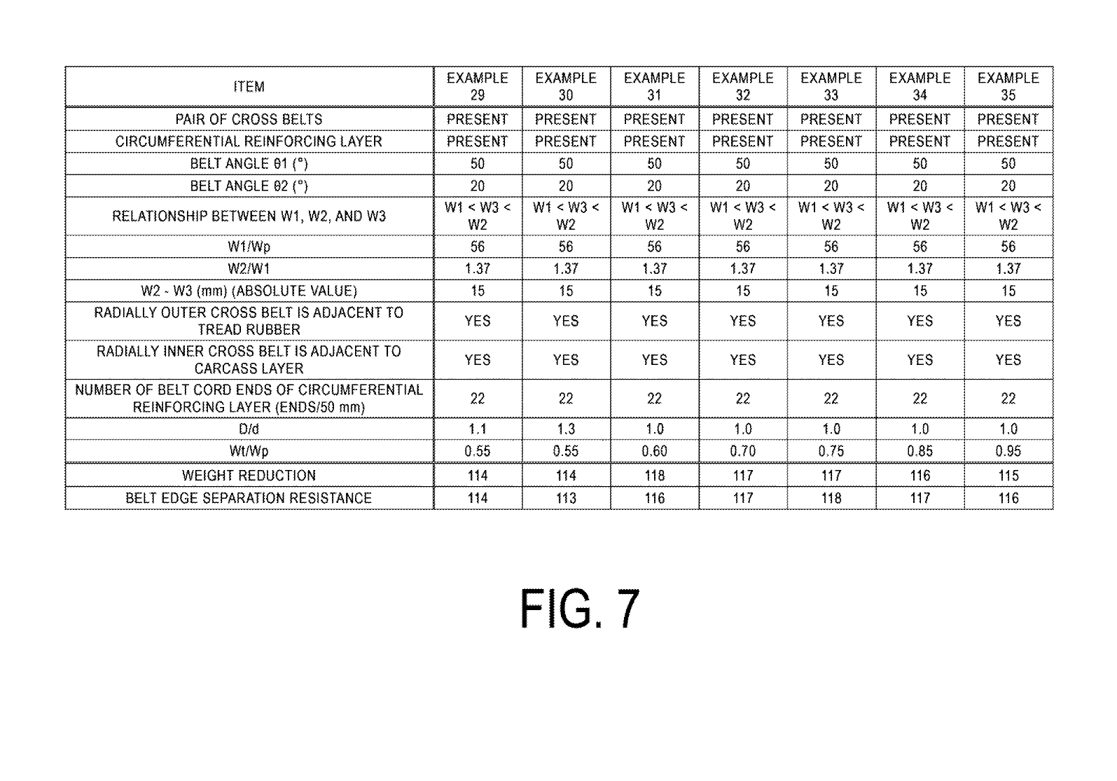

FIGS. 3 through 7 are tables showing results of performance tests of pneumatic tires according to embodiments. Hereinafter, performance evaluation tests conducted on pneumatic tires of Conventional Example, pneumatic tires of Comparative Examples, and pneumatic tires of Examples according to the embodiment will be described. For evaluation tests, tests on weight reduction and belt edge separation resistance (durability) were performed.

In the evaluation tests of weight reduction, the mass of a pneumatic tire (green tire) having a tire size of 275/80R22.5 was measured, and the reciprocal of the mass was indexed. The evaluation is expressed as index values and evaluated, with Conventional Example being assigned as the reference (100). In the evaluation, larger values are preferable.

In the evaluation tests of belt edge separation resistance, test tires having a tire size of 275/80R22.5 were assembled on standard rims specified by JATMA, and an internal pressure specified by JATMA was applied to the test tires. Then, a cambered drum testing machine having a drum diameter of 1707 mm was used, an applied load was increased from a specified load per hour, a running distance at which a failure occurs was measured, and the evaluation was performed. The evaluation is expressed as index values and evaluated, with Conventional Example being assigned as the reference (100). In the evaluation, larger values are preferable.

The pneumatic tire of Conventional Example includes a pair of cross belts in a belt layer of a three-layer structure; however, a circumferential reinforcing layer is not included between the cross belts, and the cord angle of the belt cord of the cross belt does not satisfy the definition.

The pneumatic tire of Comparative Example 1 includes a pair of cross belts in a belt layer of a three-layer structure, and a circumferential reinforcing layer is included between the cross belts; however, the cord angle of the belt cord of the radially outer cross belt and the relationship between the widths W1, W2, and W3 do not satisfy the definitions. The pneumatic tire of Comparative Example 2 includes a pair of cross belts in a belt layer of a three-layer structure, and a circumferential reinforcing layer is included between the cross belts; however, the cord angle of the belt cord of the radially inner cross belt and the relationship between the widths W1, W2, and W3 do not satisfy the definitions. The pneumatic tire of Comparative Example 3 includes a pair of cross belts in a belt layer of a three-layer structure, a circumferential reinforcing layer is included between the cross belts, and the cord angle of the belt cord of the cross belt satisfies the definition; however, the relationship between the widths W1, W2, and W3 does not satisfy the definition.

The pneumatic tires of Examples each include a pair of cross belts in a belt layer of a three-layer structure, a circumferential reinforcing layer is included between the cross belts, and the cord angle of the belt cord of the cross belt and the relationship between the widths W1, W2, and W3 satisfy the definitions.

As can be seen from the test results, in the pneumatic tires of the present Examples, weight reduction and belt edge separation resistance are improved with respect to Conventional Example.

The present disclosure includes the following technologies.

### Technology 1

A tire, including:

a carcass layer;

a belt layer disposed on an outer side of the carcass layer in a tire radial direction and continuing in a tire circumferential direction; and

a tread rubber disposed on an outer side of the belt layer in the tire radial direction;

the belt layer including:

a radially outer cross belt including a belt cord having a cord angle of 45° or more with respect to the tire circumferential direction as an absolute value;

a radially inner cross belt including a belt cord having a cord angle of 45° or less with respect to the tire circumferential direction as an absolute value with a sign opposite to that of the cord angle of the radially outer cross belt and disposed on an inner side of the radially outer cross belt in the tire radial direction; and

a circumferential reinforcing layer including a belt cord having a cord angle within a range of ±5° with respect to the tire circumferential direction and disposed between the radially inner cross belt and the radially outer cross belt, and

a width W1 of the circumferential reinforcing layer, a width W2 of the radially inner cross belt, and a width W3 of the radially outer cross belt satisfying a relationship W1 < W3 < W2.

### Technology 2

The tire according to Technology 1, wherein the width W1 of the circumferential reinforcing layer and a cross-sectional width Wp of the carcass layer satisfy a relationship 0.50 ≤ W1/Wp ≤ 0.70.

### Technology 3

The tire according to Technology 1 or 2, wherein

the width W1 of the circumferential reinforcing layer and the width W2 of the radially inner cross belt satisfy a relationship 1.25 ≤ W2/W1 ≤ 1.55, and

the width W2 of the radially inner cross belt and the width W3 of the radially outer cross belt satisfy a relationship W2 - W3 ≤ 30 mm.

### Technology 4

The tire according to any one of Technologies 1 to 3, wherein the radially outer cross belt is disposed adjacent to the tread rubber.

### Technology 5

The tire according to any one of Technologies 1 to 4, wherein the radially inner cross belt is disposed adjacent to the carcass layer.

### Technology 6

The tire according to any one of Technologies 1 to 5, wherein

the belt cord of the circumferential reinforcing layer is a steel wire, and

the number of ends of the circumferential reinforcing layer is 15 ends/50 mm or more and 30 ends/50 mm or less.

### Technology 7

The tire according to any one of Technologies 1 to 6, further comprising

at least two circumferential grooves extending in the tire circumferential direction in the tread rubber, wherein

the circumferential grooves are in a center region and a shoulder region of a tread surface, and

a thickness D of the tread rubber from a groove bottom of the circumferential groove in the center region to the belt layer and a thickness d of the tread rubber from a groove bottom of the circumferential groove in the shoulder region to the belt layer satisfy a relationship 0.8 < D/d < 1.3.

### Technology 8

The tire according to any one of Technologies 1 to 7, wherein a ground contact width Wt of the tread rubber and a cross-sectional width Wp of the carcass layer satisfy a relationship 0.60 ≤ Wt/Wp ≤ 0.95.

What is claimed is:

1. A tire, comprising:
a carcass layer;
a belt layer disposed on an outer side of the carcass layer in a tire radial direction and continuing in a tire circumferential direction; and
a tread rubber disposed on an outer side of the belt layer in the tire radial direction;
the belt layer comprising:
a radially outer cross belt comprising a belt cord having a cord angle of 45° or more with respect to the tire circumferential direction as an absolute value;
a radially inner cross belt comprising a belt cord having a cord angle of 45° or less with respect to the tire circumferential direction as an absolute value with a sign opposite to that of the cord angle of the radially outer cross belt and disposed on an inner side of the radially outer cross belt in the tire radial direction; and,
a circumferential reinforcing layer comprising a belt cord having a cord angle within a range of ±5° with respect to the tire circumferential direction and disposed between the radially inner cross belt and the radially outer cross belt, and
a width W1 of the circumferential reinforcing layer, a width W2 of the radially inner cross belt, and a width W3 of the radially outer cross belt satisfying a relationship W1 < W3 < W2.

2. The tire according to claim 1, wherein the width W1 of the circumferential reinforcing layer and a cross-sectional width Wp of the carcass layer satisfy a relationship 0.50 ≤ W1/Wp ≤ 0.70.

3. The tire according to claim 1, wherein
the width W1 of the circumferential reinforcing layer and the width W2 of the radially inner cross belt satisfy a relationship 1.25 ≤ W2/W1 ≤ 1.55, and
the width W2 of the radially inner cross belt and the width W3 of the radially outer cross belt satisfy a relationship W2 - W3 ≤ 30 mm.

4. The tire according to claim 1, wherein the radially outer cross belt is disposed adjacent to the tread rubber.

5. The tire according to claim 1, wherein the radially inner cross belt is disposed adjacent to the carcass layer.

6. The tire according to claim 1, wherein
the belt cord of the circumferential reinforcing layer is a steel wire, and
the number of ends of the circumferential reinforcing layer is 15 ends/50 mm or more and 30 ends/50 mm or less.

7. The tire according to claim 1, further comprising
at least two circumferential grooves extending in the tire circumferential direction in the tread rubber, wherein
the circumferential grooves are in a center region and a shoulder region of a tread surface, and
a thickness D of the tread rubber from a groove bottom of the circumferential groove in the center region to the belt layer and a thickness d of the tread rubber from a groove bottom of the circumferential groove in the shoulder region to the belt layer satisfy a relationship 0.8 < D/d < 1.3.

8. The tire according to claim 1, wherein a ground contact width Wt of the tread rubber and a cross-sectional width Wp of the carcass layer satisfy a relationship 0.60 ≤ Wt/Wp ≤ 0.95.
